(19) United States
(12) Patent Application Publication
(10) Pub. No.: US 2012/0293404 A1
(43) Pub. Date: Nov. 22, 2012

(54) Low Cost Embedded Touchless Gesture Sensor

(75) Inventors: Jacob Federico, Santa Clara, CA (US); Luca Rigazio, San Jose, CA (US); Felix Raimbault, Dublin (IE)

(73) Assignee: PANASONIC CORPORATION, Osaka (JP)

(21) Appl. No.: 13/111,377

(22) Filed: May 19, 2011

(51) Int. Cl. G09G 5/00

(52) U.S. Cl. 345/156

(57) ABSTRACT

An array of independently addressable optical emitters, and an array of independently addressable detectors, energized according to an optimized sequence sensing a performed gesture to generate feature vector frames that are compressed by a projection matrix and processed by a trained model to perform touchless gesture recognition.

### FIELD

The present disclosure relates generally to non-contact sensors. More particularly, the disclosure relates to a non-contact or “touchless” gesture sensor that can provide control commands to computers, mobile devices, consumer devices and the like.

### BACKGROUND

Rich interaction is a selling point in mobile consumer devices. Interfaces which are flashy, intuitive and useful are a big draw for users. To that end, multi-touch gestural interfaces have begun to be added to mobile devices. Touch screen devices almost universally use “swipe” and “pinch” gestures as part of their user interfaces. Despite their advantages, however, multi-touch gestural interfaces do have physical limitations and there are certainly situations where a “touchless” gestural interface would provide a better solution.

This problem with most touchless input systems is that they generally require physically large sensor networks, and/or significant computational resources to generate data. These two restrictions make touchless gesture controls impractical in mobile devices. First, processors used in embedded systems are typically much lower performance, and tend to be dedicated mostly to making the device responsive and enjoyable to use. There is very little computational power left for harvesting and interpreting data from a conventional touchless sensor network. Second, mobile devices are typically battery powered, and conventional touchless sensor networks tend to place a heavy power drain on the device's batteries. Third, compact design is also a constraint when dealing with mobile platforms. Conventional touchless sensor networks are simply too large to embed in a mobile device. Finally, the overall cost of conventional touchless sensors is prohibitive.

### SUMMARY

In accordance with one aspect, the low cost embedded touchless gesture sensor is implemented as a non-contact gesture recognition apparatus that employs an array of independently addressable emitters arranged in a predetermined distributed pattern to cast illumination beams into a gesture performance region. By way of example, the gesture performance region may be a predefined volume of space in front of a display panel. The non-contact gesture recognition apparatus also includes an array of independently addressable detectors arranged in a second predetermined distributed pattern. If desired, the emitters and detectors may be deployed on a common circuit board or common substrate, making the package suitable for incorporation into or mounting on a computer display, mobile device, or consumer appliance. The emitters and detectors obtain samples of a gesture within the gesture performance region by illuminating the region with energy and then sensing reflected energy bouncing back from the gestural target. While optical energy represents one preferred implementation, other forms of sensing energy may be used, including magnetic, capacitive, ultrasonic, and barometric energy.

The apparatus further includes at least one processor having an associated memory storing an illumination matrix that defines an illumination sequence by which the emitters are individually turned on and off at times defined by the illumination matrix. The processor may additionally have an associated memory storing a detector matrix that defines a detector selection sequence by which the detectors are enabled to sense illumination reflected from within the gesture performance region. If desired, the same processor used to control the illumination matrix may also be used to control the detector selection sequence. Alternatively, separate processors may be used for each function. The array of detectors provide a time-varying projected feature data stream corresponding to the illumination reflected from within the gesture performance region.

At least one processor has an associated memory storing the set of models based on time-varying projected feature data acquired during model training. At least one processor uses the stored set of models to perform pattern recognition upon the feature data stream to thereby perform gesture recognition upon gestures within the gesture performance region. The processor performing recognition can be the same processor used for controlling the illumination matrix and/or for controlling the detector selection sequence. Alternatively, a separate processor may be used for this function.

According to another aspect, the non-contact gesture recognition apparatus comprises an emitter-detector array that actively obtains samples of a gestural target and outputs those samples as a time-varying sequence of electronic data. The processor converts the time-varying sequence of electronic data into a set of frame-based projective features. A model-based decoder circuit performs pattern recognition upon the frame-based projective features to generate a gesture command. In yet another aspect, the non-contact gesture recognition apparatus comprises an emitter-detector array that actively obtains samples of a gestural target and outputs those samples as a time-varying sequence of electronic data. A processor performs projective feature extraction upon real time data obtained from the emitter-detector array using a predefined feature matrix to generate extracted feature data. A processor performs model-based decoding of the extracted feature data using a set of predefined model parameters.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exemplary view of a display monitor having disposed on top an emitter-detector array apparatus;

FIG. 2 is an exemplary mobile device tablet having emitter-detector array sensors disposed around the periphery of the device;

FIG. 3 is a perspective view showing an example of a gesture performance region in front of a display or mobile device;

FIG. 4 is a hardware block diagram showing one embodiment of the low cost embedded touchless gesture sensor apparatus;

FIG. 5 is a hardware block diagram showing the emitter subsystem of the apparatus of FIG. 4 in greater detail;

FIG. 6 is a hardware block diagram showing the detector subsystem of the apparatus of FIG. 4 in greater detail;

FIG. 7 is a signal half diagram showing the excitation signal supplied to the emitter (IR LED) and the reflective light received signals and filtered signals obtained by the detector (photo diode);

FIGS. 8a, 8b and 8c are detailed optical beam illustrations, showing how a target is perceived differently depending on which emitter-detector pairs are activated;

FIG. 9 is a waveform diagram illustrating how reflected light optical signals are sampled and combined to define a raw data frame;

FIG. 10 is a summary data flow diagram illustrating how the raw data frame is first compressed, then packaged as sets of data frames and finally fed to a pattern recognition processor to extract a gesture code;

FIG. 11 is a pattern recognition flow chart illustrating both online and offline steps that (a) generate a projective feature matrix θ and (b) use that projective feature matrix to perform Hidden Markov Model (HMM) decoding of real time gestural data;

FIG. 12 is a flow chart illustrating other aspects of the online and offline gestural recognition steps;

FIG. 13 is a plan view of an exemplary circuit board or substrate whereby the array of independently addressable optical emitters and array of independently addressable photo detectors are arranged in respective predetermined distributed patterns;

FIG. 14 is an exploded perspective view, showing one possible packaging configuration for the non-contact gesture recognition apparatus.

Corresponding reference numerals indicate corresponding parts throughout the several views of the drawings. Example embodiments will now be described more fully with reference to the accompanying drawings.

### DESCRIPTION OF THE PREFERRED EMBODIMENTS

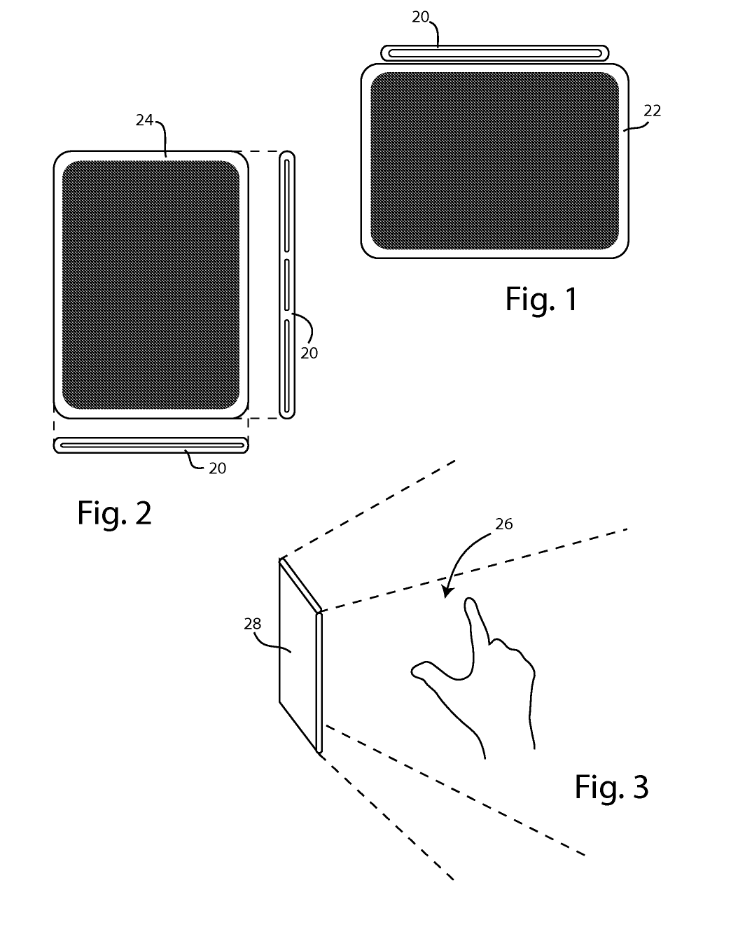

The non-contact gesture recognition apparatus may be implemented in a variety of different physical configurations as may be suited for different applications. By way of example, two applications of the apparatus have been illustrated in FIGS. 1 and 2. FIG. 1 shows the non-contact gesture recognition apparatus 20 mounted atop a display screen 22. This application may be suitable, for example, in a medical environment where a doctor needs to control a computer or electronic medical apparatus attached to display 22, without making any physical contact with touch screen, keyboard, mouse or other control device. The need for such “touchless” control is driven by hygienic requirements. During surgery, for example, the physician's hands and gloves must remain sterile. Hence, making physical contact with a keyboard or mouse is undesirable.

The exemplary embodiment of FIG. 2 shows a mobile device such as a computer tablet, mobile phone, game apparatus or other consumer appliance, shown generally at 24. The non-contact gesture recognition apparatus is built into or embedded in the device, such as by attaching to or embedding within the outer periphery of the device, as illustrated. In this embodiment, gestural movements made in the vicinity of the device periphery or by actually touching the periphery, are interpreted as gestural commands as will be more fully discussed herein.

While FIGS. 1 and 2 provide two exemplary uses of the non-contact gesture recognition apparatus, it will be understand that many other configurations are possible. Thus, while a display screen has been featured in both of the above examples, the non-contact gesture recognition apparatus can also be used to provide command and control signals to electronic devices which do not have a display screen. For exampled, in some automotive applications, a display screen might be dispensed with so that the user's attention can remain focused on driving the vehicle. Gestural commands are still useful in this application to control devices that do not require visual display.

The non-contact gesture recognition apparatus uses a trained model to recognize a variety of different gestural movements that are performed within a gestural performance region, typically a volume of space generally in front of the gesture recognition apparatus. The apparatus works by emitting illumination from an array of independently addressable optical emitters into the gesture performance region. Independently addressable photo detectors, trained on the gesture performance region, detect reflected light from gestures performed in the performance region and interpret those detected reflected light patterns by extracting projective features and interpreting those features using a trained model.

FIG. 3 illustrates an exemplary gesture performance region 26 as a volume of space in the “near field” in front of the mobile device 28. Suitable hand gestures performed within this gesture performance region 26 are analyzed by the gesture recognition apparatus to determine what gesture has been made. As will be more fully explained, the trained computer-implemented models, trained a priori, are utilized by the processor to perform gesture recognition of gestural motions performed within the gesture performance region 26.

For most applications, the gesture performance region 26 lies in the “near field” of the optical emitters and photo detectors, such that the angle of incidence and distance from emitter to gestural target and distance from detector to gestural target are all different on a sensor-by-sensor and emitter-by-emitter basis. In other words, the gesture performance region occupies a volume of space close enough to the emitters and detectors so that the light reflected from a gestural target onto the photo detectors arrives at each detector at a unique angle and distance vis-á-vis the other detectors. Thus, the gesture performance region in such cases differs from the “far field” case where the distance from emitter to gestural target (and distance from gestural target to emitter) is so large that it may be regarded as the same for all of the emitters and detectors.

By being trained upon a near field gestural performance region, the optical emitters and photo detectors of the gesture recognition apparatus differ from a CCD camera array, that receives an optical image focused through lenses so that an entire volume of space is projected flat onto the CCD array, thereby discarding differences in angle of instance/reflection on a sensor-by-sensor basis. The CCD camera works differently in that light reflects from a target uniformly illuminated and onto the CCD detectors simultaneously through a focusing lens.

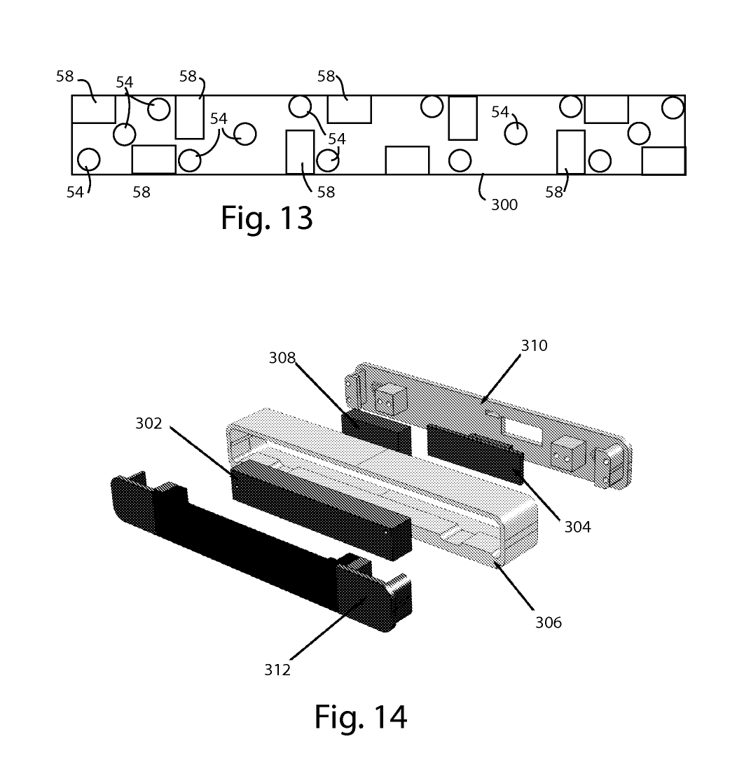

The gesture recognition apparatus uses independently addressable optical emitters and independently addressable photo detectors are arranged in respective distributive patterns (see FIG. 13) and are activated by a processor controlled illumination sequence and detector selection sequence whereby light is projected selectively at different angles and picked up selectively by selected detectors to acquire a rich set of feature information that has been analyzed by the pattern recognizer.

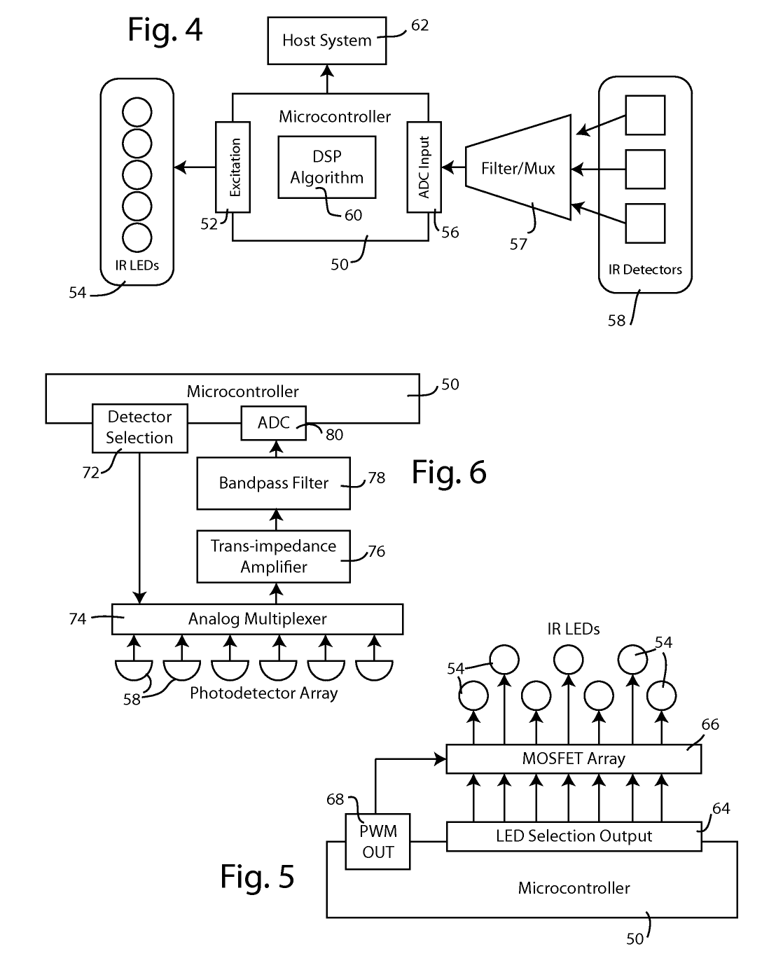

Referring to FIG. 4, a block diagram of a preferred embodiment of the gesture recognition apparatus includes a microcontroller or processor 50 that programmatically controls the excitation circuitry 52, which in turn selectively illuminates different ones of the independently addressable optical emitters 54 according to a predetermined pattern. The optical emitters can be infrared LEDs, which have the advantage of producing optical energy that lies outside the human visible range. In a presently preferred embodiment, the excitation circuitry 52 produces a modulated excitation signal which can be better discriminated from ambient background light and noise.

The microcontroller 50 also programmatically controls an analog to digital converter (ADC) input circuit 56, which receives reflected light information from the array of independently addressable photo detectors 58. The photo detectors produce electrical signals in response to optical excitation (from reflected light) and these signals are processed by hardware filters and sampled by a multiplexer circuit 57 according to a predetermined detector selection sequence and then suitably filtered as will be more fully explained below.

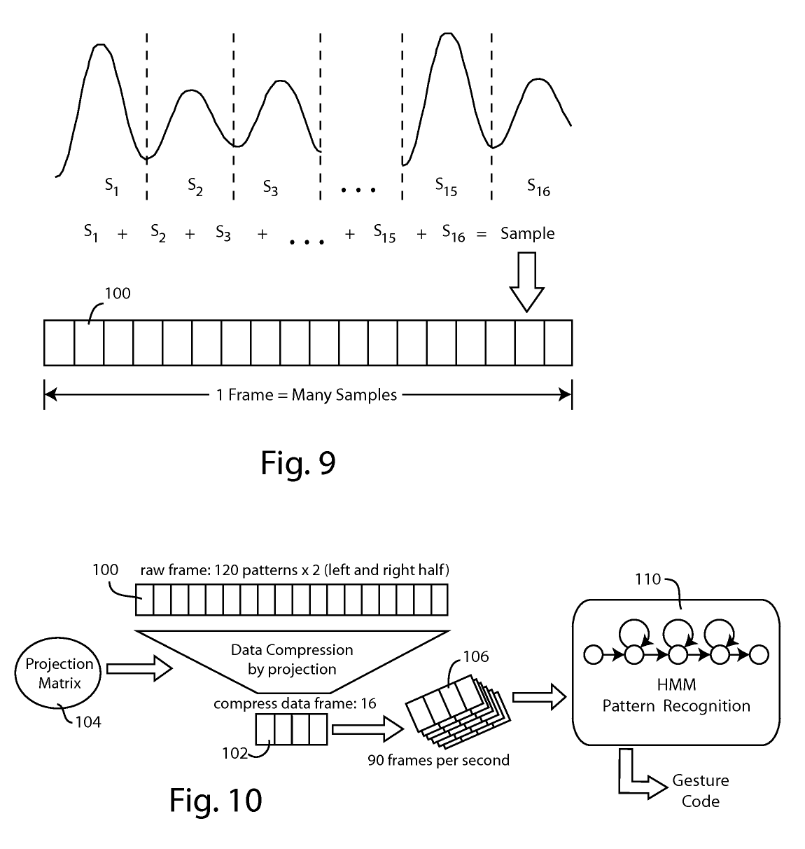

Microcontroller 50 communicates with or serves as a host for a digital signal processing algorithm, shown diagrammatically at 60. The digital signal processing algorithm is implemented by suitable computer program instructions, implemented by microcontroller 50 and/or other processor circuitry, to perform the signal processing steps described in connection with FIG. 9-12 below.

Microcontroller 50 extracts gesture information from light reflected from gestural targets within the gesture performance region. It extracts gestural information using trained Hidden Markov Models and/or other pattern recognition processes to produce a gesture code indicative of the gesture having the highest probability of having been performed. This gesture code may then be supplied as a control signal to a host system 62 according to a suitable common communication protocol, such as RS232, SPI, I2C, or the like. The host system may be, for example, an electronically controlled medical diagnostic apparatus, a mobile device such as tablet, computer, cellular phone or game machine, or other consumer appliance.

In the simplified block diagram of FIG. 4, the independently addressable optical emitters 54 and the independently addressable photo detectors 58 each implement their own predetermined distributed patterns and may be physically positioned in various ways. The emitter and detector devices can be linearly arranged, as diagrammatically illustrated in FIG. 4, for example; or they may be arranged in a more complex way, as illustrated in FIG. 13. In FIG. 13 the optical emitters and photo detectors are commingled in a more intricate distributed pattern.

Relatively high resolution is achieved by selectively illuminating and sampling light emitting patterns with different groups of detectors. This allows comparative measurements and interpolation, and thus allows a more complete extraction of information from the data sample. To maximize effectiveness, a set of the most meaningful emitter patterns and detector groups is constructed via offline computation on raw data. A precomputed projection matrix is then used to compress data so it can be efficiently processed by the on-board processor (microcontroller and DSP algorithm). In this way precomputation is leveraged to allow real time gesture recognition results at run time.

In addition to providing high resolution, the use of selectively addressable emitters and detectors allows those components to be arrayed in a wide variety of ways, which allows for many different physical configurations and form factors and also allows for programmatic changes in resolution and performance based on constraints placed on the system by the host system and/or its application.

Referring now to FIG. 5, the optical emitter portion of the circuit of FIG. 4 has been shown in greater detail. The microcontroller 50 has a bank of output ports designated as LED selection output 64, which selectively energizes different ones of the optical emitters 54 according to a predetermined illumination matrix stored in the memory associated with microcontroller 50.

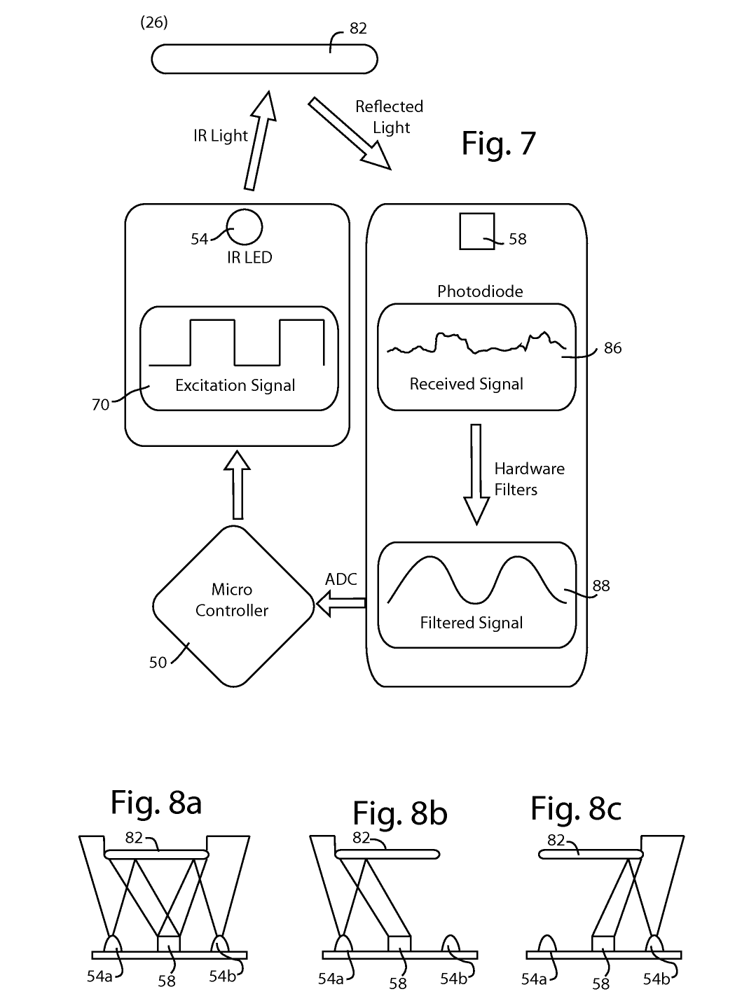

Actual energization of the optical emitters is performed by MOSFET array circuitry 66 which is driven by pulse width modulated (PWM) driver circuit 68. The PWM driver circuit generates a square wave signal, centered at a predetermined modulation frequency. This signal is used as an enable signal for the MOSFET array. The pulse width modulated driver circuit 68 and MOSFET array 66 thus supply an excitation signal to an optical emitter 54 (when selected via LED selection output 64) that cycles on and off at a predetermined modulation frequency. Modulating the excitation signal includes the produced infrared light in a manner that allows it to be discriminated from other spurious illumination also present in the gesture performance region. FIG. 7 shows an exemplary excitation signal at 70.

The microcontroller 50 is able to individually turn on or off an individual LED by changing the state of its output pins (by controlling the LED selection output 64). These outputs are also wired to the MOSFET array 66. A given LED will only be turned on if both the corresponding input to the MOSFET array for that LED is high, and the output from the PWM driver circuit 68 is high. In this way the entire array is always synchronized to the PWM square wave driver signal, and yet any combination of LEDs may be turned on or off based on the outputs from the LED selection output 64 controlled by the microcontroller 50.

Referring now to FIG. 6, the photo detector section of FIG. 4 will now be described. Microcontroller 50 includes an output port designated as detector selection port 72 that controls an analog multiplexer circuit 74 to which each of the photo detectors 58 are coupled. The multiplexer circuit is operated by the microcontroller, via detector selection output 72, to selectively couple the output of selected one or more photo detectors 58 to a trans-impedance amplifier circuit 76. The amplifier circuit converts the current-based signal of the photo detectors into a voltage-based signal and also applies gain to the signal. The amplifier circuit supplies the boosted voltage-based signals to a band pass filter 78, which may be implemented as an active or an inactive filter, centered on the modulation frequency of the PWM driver circuit 68. The band pass filter is thus tuned to select or emphasize signals pulsating at the frequency of the excitation signal (see FIG. 7) thereby increasing the signal-to-noise ratio of the reflected light signal coming from a target within the gesture performance region. The output of band pass filter 78 is fed to analog to digital converter (ADC) circuit 80 where the digital information is then supplied to the DSP algorithm 60 (FIG. 4).

As illustrated in FIG. 7, the modulated infrared light from emitter 54 will bounce or scatter off any object it hits, reflecting back onto the photo detector array. Thus modulated infrared light from emitter 54 reflects from a target 82 within the gesture performance region 26 and impinges upon the photo detector 58 as the reflected light signal. The photo detector converts the reflected light signal into an electrical signal shown as the received signal 86 in FIG. 7. The band pass filter 82 (hardware filters) produce a filtered signal 88 that carries the essential information to qualify as having been generated by the excitation signal 70. As shown in FIG. 7, the filtered signal and excitation signal both have the same frequency, although the filtered signal is a more rounded waveform with less clearly defined on-off rising and falling edges.

The non-contact gesture recognition apparatus advantageously cycles the emitters and detectors on and off in predefined patterns to collect raw data that supplies information about the gestural movement within the gesture performance region. FIGS. 8a, 8b and 8c illustrate how this works. Because each detector sees reflected light from a viewing angle different from the other detectors, each detector is capable of providing unique information about the location and movement of the gestural target. By selectively energizing one or more emitters and by selectively reading from one or more specific detectors, rich information is gleaned about the gestural movement. This approach improves granularity of the raw data without increasing the number of emitting and detecting elements. The microcontroller selectively controls the number of emitting elements that are on and off based on which detector is currently being sampled. Thus, the data provided by each detector is slightly different and thus provides new information that does not significantly overlap with the information gleaned from other detectors.

FIG. 8a illustrates the case where detector 58 measures reflected light from emitters 54a and 54b, which are turned on simultaneously. By comparison, FIG. 8b shows the case where detector 58 receives reflected light from only emitter 54a. FIG. 8c shows the case where only emitter 54b provides illumination. Even though the same detector 58 is used in each case, the reflected light from gestural target 82 provides different information in each case. In FIG. 8a, where both emitters 54a and 54b are illuminated, the illumination is (a) more intense and (b) impinges upon both right and left extremities of target 82. Having a higher intensity, the combined illumination from emitters 54a and 54b can reach further into the gestural performance region. Thus, when the entire gestural performance region is considered, the energizing of multiple emitters concurrently will tend to examine the volumetric portion of the gesture performance region that lies further from the detectors. Conversely, energizing single emitters (as in the examples of FIGS. 8b and 8b) illuminates the volumetric region that lies closer to the detectors.

While covering a shorter range, single emitters provide more precise, pinpoint information about the gestural target. This can be seen by comparing FIGS. 8b and 8c. In FIG. 8b, the left side of target 82 provides information that is captured by the detector 58. In contrast, FIG. 8c shows that by energizing emitter 54b, the right side of the target 82 provides reflected light information to the detector 58.

To appreciate how each emitter-detector combination provides unique information, recognize that emitter 58 produces an electrical signal that is proportional to the intensity of the reflected light received. Thus, when both emitters 54a and 54b are simultaneously illuminated (FIG. 8a), a comparatively high intensity received signal is generated. This provides information that a target is present in front of the detector 58, but provides little information about the precise location of the left and right edges thereof. When emitter 54a is illuminated alone, the detector 58 receives information about the left edge of the target, but no information about the right edge of the target (see FIG. 8b). Similarly, when emitter 54b is energized alone, the detector 58 receives information about only the right edge of the target (see FIG. 8c).

While all three cases illustrated in FIGS. 8a, 8b and 8c provide some information that a target object is present within the gesture performance region, the information provided in each case is different. To illustrate, consider the case where gestural movement of the target is from right to left as seen in FIGS. 8a, 8b and 8c. Such movement will be immediately detected by the case shown in FIG. 8c, whereas it would not be detected in FIG. 8b until later, when the right edge of the target has finally passed beyond the illumination range of emitter 54a.

The microcontroller 50 cycles the energizing of selected emitters and the reading of selected detectors through a predetermined sequence according to an illumination matrix and a detector matrix that are stored within memory addressed by the microcontroller. The microcontroller cycles through this pattern at a predefined cycle rate, thereby gathering a plurality of raw data samples that convey information about the gestural target and its movement.

By way of example, FIG. 9 shows how the individual samples (S₁, S₂ . . . Sₙ) are collected and assembled into a frame 100. Because the signals have been processed through filters they appear as roughly sinusoidal waveforms. One preferred embodiment analyzes signals using a sub-sampling technique. A sub-sample is generated by subtracting a value captured at the peak of the incoming signal from a value captured at the trough of the incoming signal. A series of these sub-samples is collected and accumulated to help increase resolution and robustness to noise, where the accumulation of such sub-samples is considered to be one sample. The exact number of collected sub-samples may vary depending in the implementation of the system. These samples are collected and packaged into a vector, as by concatenating the samples sequentially into a linear sequence. Thus the index into this vector corresponds to a specific pattern of emitters being active, paired with a specific detector being active. Thus each index is representative of a specific sampling condition.

In one embodiment, the arrays of independently addressable emitters and detectors may be physically arranged in an elongated structure such as that shown in FIG. 13. Moreover, if desired, the emitter-detector arrays can be configured to have bilateral symmetry, where the left half side of the array is a mirror image of the right half side. If desired, each of the left and right half sides can be separately processed. In such an embodiment, a raw frame of, for example, 120 samples is collected from each side to constitute a raw frame of 240 data samples, corresponding to 120 different illumination-detection pairs.

Instead of operating directly upon these raw data frames, the preferred embodiment performs additional processing on the raw data to reduce the raw frame data size from 240 samples (120 patterns for each of the left and right sides of the sensor array) into a compressed data frame of 16 samples. As illustrated in FIG. 10, this data compression is performed by a projection operation. Specifically, the raw frame 100 is converted into a compressed data frame 102 using a projection matrix 104 as will be more fully described. The compressed data frame 102 is then assembled with other previously recorded data frames to comprise a data frame packet 106 at a predefined frame rate, for example, 90 frames per second. While a 90 frame per second rate has proven to be workable in this presently preferred embodiment, it will be appreciated that other frame rates may be used.

Each compressed data frame 102 may be considered as a feature vector comprising the linear combination of individual “features” distilled from the raw data samples 100. Thus, each compressed data frame 102 within the packet 106 represents the features that are found at a particular instance in time (e.g., each 1/90^{th} of a second). These feature vectors are supplied to a Hidden Markov Model (HMM) pattern recognition process 110 that is performed by the DSP algorithm implemented by the microcontroller 50 (see FIG. 4). The result of such pattern recognition is a gesture code that the microcontroller then supplies to the host system 62 (FIG. 4) as a control signal to produce certain behavior within the host system.

The selection of patterns used in the non-contact gesture recognition apparatus is preconfigured as follows. Even with a small, finite set of emitters and a small, finite set of detectors, the number of possible combinations is very large. In order to reduce the pattern set size, and yet ensure that all relevant data are still present, a data driven pattern selection approach is taken. The general approach is to make a gross, first pass data reduction step or “rough cut” to remove many of the redundant and/or low information carrying patterns. This is done using dynamic range analysis by subtracting the maximum observed value from the minimum observed values. If the result of such subtraction is small, the pattern may be assumed to carry little or no useful data. After discarding these low-data or trivial patterns, a second data reduction step is performed to maximize the information in the set of patterns. This second reduction step reduces the pattern set size such that a sampling rate of at least 50 Hz. is achieved, and preferably a sampling rate of 80 Hz. to 100 Hz. This reduction technique maximizes the relevance of each pattern, while simultaneously minimizing the redundancy between features, by applying the following equations.

Minimize Redundancy:

$$min {W}_{1} , {W}_{1} = \frac{1}{{\vert S \vert}^{2}} {\sum }_{i , j ∈ S} I ( i , j )$$

Maximize Relevance:

$$max {V}_{1} , {V}_{1} = \frac{1}{\vert S \vert} {\sum }_{i ∈ S} I ( h , i ) \qquad$$

(S: Set of features, h: Target classes, I(i,j): Mutual information between features i and j).

After performing the above processes to minimize redundancy and maximize relevance, the remaining patterns are then sorted and additional limitations can then be applied to further reduce or tailor the results. For example, a minimum or maximum LED count can be put in place where the gesture recognition apparatus needs to have more range (increase LED count), or lower power requirements (lower LED count).

After performing the gross, first pass reduction step, a further data reduction second pass step is preferably performed. The second pass step is a data compression step using a linear mapping whereby the raw data set is treated as a vector, which is then multiplied by a precomputed matrix, resulting in a reduced size vector. This compressed data set is then used as the input to a pattern recognition engine.

In one presently preferred embodiment the pattern recognition engine may include a Hidden Markov Model (HMM) recognizer. Ordinarily an HMM recognizer can place a heavy computational load upon the processor, making real time recognitions difficult. However, the present system is able to perform complex pattern recognition, using HMM recognizer technology, in real-time, even though the embedded processor does not have a lot of computational power. This is possible because the recognition system feature vectors (patterns) have been optimally chosen and compressed, as described above. The system can thus be tuned for performance or system requirements by changing the amount of compression to match the available memory footprint.

After pattern recognition, the output of the pattern recognition engine may be transmitted, as a gesture code to the host system, using any desired communication protocol. Optionally, additional metadata can be sent as well. Some useful examples of such metadata include the duration of the gesture (number of data frames between the start and end of the gesture). This gives the system an idea of how fast the gesture was performed. Another example is the average energy of the signal during the gesture. This reflects how distant from the sensor the gesture was made. Metadata may also include a confidence score, allowing the host system to reject gestures that do not make sense at the time or to more strictly enforce recognition results to ensure results are correct, at the expense of ignoring a higher percentage of user inputs.

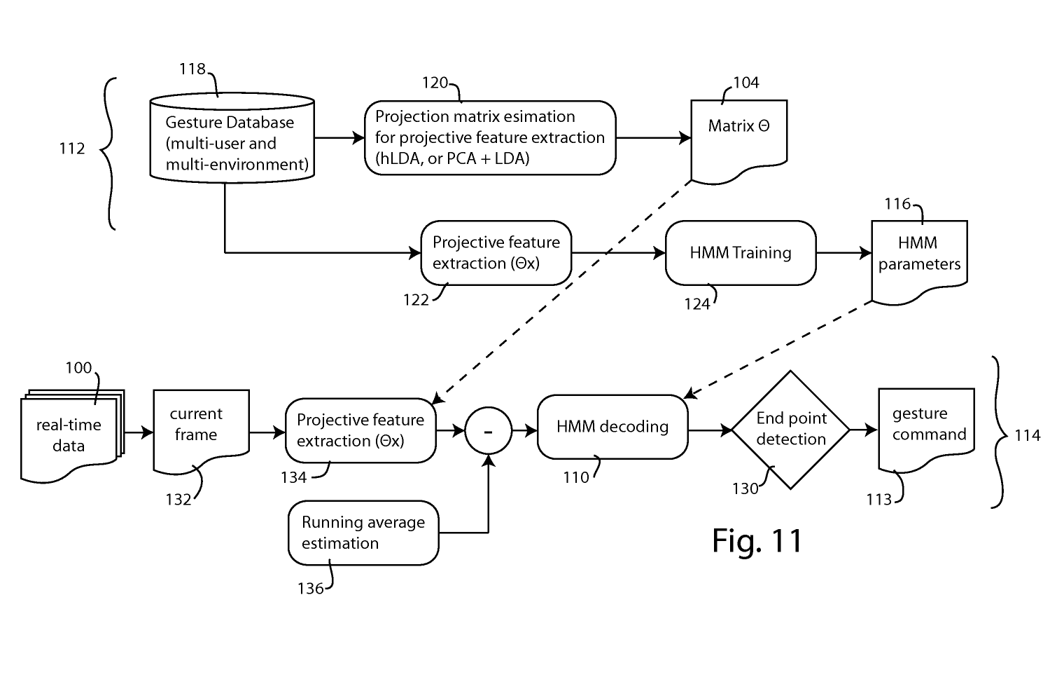

The Hidden Markov Model pattern recognition process 110, and the associated preprocessing steps illustrated in FIG. 10 can be better understood with reference to FIG. 11. In FIG. 11, the Hidden Markov Model recognition process corresponds to the HMM decoding block 110. The projection matrix is shown at 104. The Hidden Markov Model pattern recognition process involves two phases: a training phase shown generally at 112 and a test phase or use phase shown generally at 114. The training phase generates the projection matrix Θ 104 and also generates the HMM parameters 116 that are used by the HMM decoding block 110. The training phase 112 will be described first.

### Generating the Matrix Θ

One step in the training phase involves generating the projection matrix Θ. This is performed using a gestural database 118 comprising a stored collection of gestural samples performed by multiple users and in multiple different environments (e.g., under different lighting conditions, with different backgrounds and in various different gesture performance regions) obtained using the different combinations of emitter-detector patterns of the gesture recognition apparatus. The patterns used are those having been previously identified as having minimum redundancy and maximum relevance, as discussed above. The gesture database is suitably stored in a non-volatile computer-readable medium that is accessed by a processor (e.g., computer) that performs a projection matrix estimation operation at 120.

Projection matrix estimation 120 is performed to extract projective features that the test phase 114 then uses to extract features from a compressed data frame prior to HMM decoding. Projection matrix estimation 120 may be achieved through various different dimensionality reduction processes, including Heteroscedastic Linear Discriminate Analysis (HLDA), or Principal Component Analysis (PCA) plus Linear Discriminate Analysis (LDA). The details of HLDA can be found in On Generalizations of Linear Discriminant Analysis by Negendra Kumar and Andreas G. Andreou.

More specifically, HLDA or another dimensionality reduction process, is applied to the incoming data frames from database 118 to produce a compressed frame of lower dimensionality. A linear mapping style of compression is used as the means of projective feature extraction because it is simple and efficient to implement on an embedded system. In this regard many microcontrollers include special instructions for fast matrix multiplication.

### Training the Hidden Markov Models

The projection matrix Θ 104 is next used by the projective feature extraction process 122 to operate upon training examples of various different gestures performed by different people, which may be independently supplied or otherwise extracted from the gesture database 118. Examples of different gestures include holding up one, two or three fingers; waving the hand from side to side or up and down, pinching or grabbing by bending the fingers, shaking a finger, and other natural human gestures. Process 122 applies the projection matrix Θ to reduce the dimensionality of the raw training data to a compressed form that can be operated upon more quickly and with less computational burden. These compressed data are used by the HMM training process 124 to generate HMM parameters 116 for each of the different gestures.

Having generated the projection matrix Θ 104 and the HMM parameters 116 for each different gesture, the training component 112 is now complete. Projection matrix Θ 104 and HMM parameters 116 are stored within the non-transitory computer-readable media associated with the gesture recognition apparatus, where the matrix and HMM parameters may be accessed by the microcontroller and DSP processes to implement the test phase or use phase 114.

### Test Phase (Use Phase)

In the test phase or use phase the user performs a gesture, unknown to the gesture recognition apparatus, within the gesture performance region. Using its pattern recognition capabilities the gesture recognition apparatus selects which of its trained models the unknown gesture most closely resembles and then outputs a gesture command that corresponds to the most closely resembled gesture. Thus when the surgeon performs a hand gesture in front of the display screen of FIG. 1, that surgeon is operating the device in the test phase or use phase.

As illustrated at 114 (the lower half of FIG. 11) the test phase or use phase operates upon real time raw data frames 100, which are supplied by the detector array after having been processed by the trans-impedance amplifier 76 and band pass filter 78 (FIG. 6). These raw data frames are individually selected at a sampling rate (e.g., 90 frames per second) by the detector selection output 72 (FIG. 6) under control of the microcontroller 50. Thus each frame (e.g., the current frame 132) is operated upon in sequence.

The DSP processor performs projective feature extraction upon the current frame 132 as at 134 by multiplying the current frame data with the projection matrix θ stored as a result of the training component. From the resultant projective features extracted, a running average estimation value 136 is subtracted, with the resulting difference being fed to the HMM decoding process 110. Subtraction of the running average performs high pass filtering upon the data, to remove any dc offsets caused by environmental changes. In this regard, the amplifier gain stage is non-linear with respect to temperature; subtraction of the running average removes this unwanted temperature effect. The HMM decoding process uses the HMM parameters 116 that were stored as a product of the training phase 112 to perform estimation using the Baum-Welch algorithm. HMM decoding produces a probability score associated with each of the trained models (one model per gesture), allowing the model with the highest probability score to be selected as the gesture command candidate. In a presently preferred embodiment the Viterbi algorithm is used to decide the most likely sequence within the HMM, and thus the most likely gesture being performed. End point detection 130 is used to detect when the gesture has completed. Assuming the gesture command candidate has been recognized with a sufficiently high probability score to be considered reliable, the candidate is then used to generate a gesture command 113 that is fed to the host system 62 (FIG. 4).

In practice, the training component 112 is implemented using a first processor (training processor) such as a suitably programmed computer workstation. The test component or use component 114 is performed using the microcontroller and associated DSP processes of the gesture recognition apparatus depicted in FIGS. 4-6.

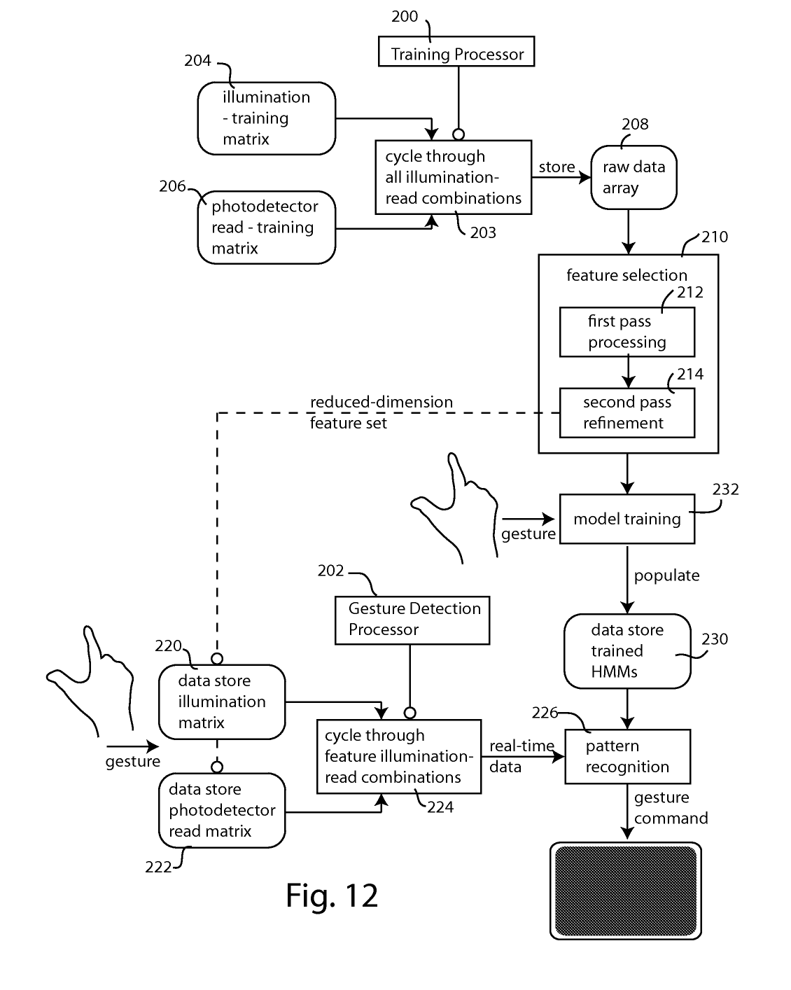

FIG. 12 expands upon the explanation provided in FIG. 11, showing those processes performed by the training processor 200 and those processes performed by the gesture detection processor 202. The gesture detection processor 202 may be implemented by the microcontroller 50 (FIG. 4) and/or by a digital signal processor circuit (DSP) coupled to or associated with the microcontroller 50. Beginning at step 203, the training processor 200 cycles through all illumination-read combinations either algorithmically or by accessing a pre-stored matrix of all different training combinations that describe which emitter or emitters are to be turned on in a given cycle and which detectors are then to be selected to read the resulting reflected light information. For illustration purposes, an illumination training matrix 204 and a photo detector read-training matrix 206 have been illustrated. As noted above, as an alternative to controlling the illumination-read cycle by following a stored matrix, the training processor can generate its own cycling by algorithm.

At this stage of the training, there is no attempt made to train the system upon any particular set of gestures. Rather, the training cycle is simply run for an extended period of time so that a large collection of raw data may be collected and stored in the raw data array 208. The objective at this stage is to obtain multiple samples for each different illumination-read combination under different ambient conditions, so that the illumination-read combinations that produce low relevancy, high redundancy data can be excluded during the first pass 212 of the feature selection phase 210. For example, the emitter-detector array may be placed in a test fixture where objects will sporadically pass through the gesture performance region over a period of several days. This will generate a large quantity of data for each of the individual illumination-read combinations.

In the feature selection phase 210, the first pass processing 212 involves excluding those illumination-read combinations that are redundant and/or where the signal to noise ratio is low. This may be performed, for example, by performing a correlation analysis to maximize entropy and using a greedy algorithm to select illumination-read combinations that are maximally uncorrelated. By way of example, the initial data collection phase may generate on the order of 60,000,000 data samples that are stored in the raw data array 208. The first pass processing 212 reduces these 60,000,000 samples to a much smaller number, on the order of approximately 500 to 1,000 elimination-read combinations, representing the maximally uncorrelated features. After the greedy algorithm has reduced the feature set, an optional tuning process may be performed to optimize results for particular applications. This would include, for example, adding extra LEDs in certain illumination-read combinations to increase the illumination intensity for a longer reach, or by removing extra LEDs to achieve longer batter life.

Next, in step 214, a second pass refinement is performed by constructing a linear combination of the maximally uncorrelated features and then performing a dimensionality reduction process via principal component analysis (PCA), linear discriminant analysis (LDA) or Heteroscedastic Linear Discriminate Analysis (HLDA). The dimensionality reduction step reduces the 500 to 1,000 maximally uncorrelated features down to a set of approximately 120 features.

The reduced dimensionality feature set is then stored in the data store associated with the gesture detection processor 202 to define both the illumination matrix 220 and the photo detector read matrix 222. The gesture detection processor 202 cycles through these reduced-dimensionality feature (illumination-read) combinations as at 224 to collect real time data that are fed to the pattern recognition process 226. The pattern recognition process may be performed by the gesture detection processor 202 using its associated data store of trained Hidden Markov Models 230 that were trained by analyzing different training gestures using the reduced-dimensionality feature set.

While an HMM embodiment is effective at identifying different gestures, other statistically-based processing techniques can also be used, either alone or combined with HMM techniques. To track the movement of a target, such as the user's finger, a K-nearest neighbor (K-NN) algorithm may be used. Training data may consist of a predetermined number of classes (e.g., 10 classes) where each class indicates each point where the user may place his or her finger in front of the emitter-detector array. Once trained, the K-NN algorithm is applied by a processor to find the nearest class as new data comes in. Interpolation between classes (between points along the linear extent of the emitter-detector array).

As previously noted, the emitters and detectors can be arranged in a variety of different ways, depending on the product being supported. FIGS. 13 and 14 show an exemplary arrangement as would be suitable for the application shown in FIG. 1. Referring to FIG. 13, the individual emitters 54 and detectors 58 are mounted or disposed on a circuit board or substrate 300. As shown in FIG. 14, the combined substrate with emitters and sensors can be prepackaged in an optional enclosure to define a sensor array 302. The associated electronic circuitry, such as the processor, band pass filter, multiplexer, trans-impedance amplifier and the like may then be mounted on a circuit board 304, and the circuit board 304 and sensor array 302 may then be disposed within an enclosure shell 306 along with a battery 308 which provides power to the circuit board 304 and sensor array 302. A back plate 310 and front face 312 secure to the enclosure shell to define a finished sensor package. The front face 312 is suitably transparent to infrared light, as is the enclosure of the sensor array 302.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A non-contact gesture recognition apparatus comprising:
an array of independently addressable emitters arranged in a predetermined distributed pattern to cast illumination beams into a gesture performance region,
an array of independently addressable detectors arranged in a second predetermined distributed pattern;
at least one processor having an associated memory storing an illumination matrix that defines an illumination sequence by which the emitters are individually turned on and off at times defined by the illumination matrix;
said at least one processor having an associated memory storing a detector matrix that defines a detector selection sequence by which the detectors are enabled to sense illumination reflected from within the gesture performance region;
the array of detectors providing a time-varying projective feature data stream corresponding to the illumination reflected from within the gesture performance region;
said at least one processor having an associated memory storing a set of models based on time-varying projective feature data acquired during model training;
said at least one processor using said stored set of models to perform pattern recognition upon said feature data stream to thereby perform gesture recognition upon gestures within the gesture performance region.

2. The apparatus of claim 1 wherein the emitters are selectively energized at a predefined modulation frequency.

3. The apparatus of claim 1 further comprising band pass filter tuned to a predefined frequency and operable to filter the projective feature data stream provided by said detectors.

4. The apparatus of claim 1 wherein the illumination matrix and the detector matrix are collectively optimized to minimize information redundancy of the projective feature data stream.

5. The apparatus of claim 1 wherein the illumination matrix and the detector matrix are collectively optimized to maximize information relevance of the projective feature data stream.

6. The apparatus of claim 1 wherein the illumination matrix and the detector matrix are collectively optimized to minimize information redundancy of the projective feature data stream by using a predefined set of features.

7. The apparatus of claim 1 wherein the illumination matrix and the detector matrix are collectively optimized to maximize information relevance of the projective feature data stream by using a predefined set of features.

8. The apparatus of claim 6 wherein said predefined set of features satisfies the relationship:
$$min {W}_{1} , {W}_{1} = \frac{1}{{\vert S \vert}^{2}} {\sum }_{i , j ∈ S} I ( i , j )$$
where S is the set of features, h represents the target classes, and I(i,j) represent mutual information between features i and j.

9. The apparatus of claim 7 wherein said predefined set of features satisfies the relationship:
$$max {V}_{1} , {V}_{1} = \frac{1}{\vert S \vert} {\sum }_{i ∈ S} I ( h , i )$$
where S is the set of features, h represents the target classes, and I(i,j) represent mutual information between features i and j.

10. The apparatus of claim 1 further wherein said at least one processor generates the projective feature data stream as a set of compressed data frames by applying a pre-calculated projection matrix to raw projective feature data obtained from said detectors.

11. The apparatus of claim 1 further wherein the processor communicates with a host system and wherein the processor performs end point detection in conjunction with pattern recognition to produce a gesture command issued to the host system.

12. A non-contact gesture recognition apparatus comprising:
an emitter-detector array that actively obtains samples of a gestural target and outputs those samples as a time-varying sequence of electronic data;
a processor that converts the time-varying sequence of electronic data into a set of frame-based projective features;
a model-based decoder circuit that performs pattern recognition upon the frame-based projective features to generate a gesture command.

13. The apparatus of claim 12 or 22 wherein the emitter-detector array is energized in a predetermined pattern of different emitter-detector combinations to obtain the samples.

14. The apparatus of claim 12 or 22 wherein the processor activates the emitter-detector array in a predetermined pattern of different emitter-detector combinations based on at least one stored matrix.

15. The apparatus of claim 14 wherein the stored matrix defines predetermined emitter-detector patterns that are preselected based on minimizing redundancy.

16. The apparatus of claim 14 wherein the stored matrix defines predetermined emitter-detector patterns that are preselected based on maximizing relevance.

17. The apparatus of claim 12 or 22 wherein the processor converts the time-varying sequence into a compressed set of features by applying a predetermined projection matrix.

18. The apparatus of claim 12 or 22 wherein the model-based decoder circuit employs at least one trained Hidden Markov Model.

19. The apparatus of claim 12 or 22 wherein the model-based decoder circuit employs at least one nearest neighbor algorithm.

20. The apparatus of claim 12 or 22 wherein the decoder circuit performs end point detection to ascertain when a gesture is completed.

21. The apparatus of claim 12 or 22 wherein the decoder circuit generates a gesture command after ascertaining when a gesture is completed.

22. A non-contact gesture recognition apparatus comprising:
an emitter-detector array that actively obtains samples of a gestural target and outputs those samples as a time-varying sequence of electronic data;
a processor performing projective feature extraction upon real-time data obtained from the emitter-detector array using a predefined feature matrix to generate extracted feature data;
a processor performing model-based decoding of the extracted feature data using a set of predefined model parameters.

23. A method of performing non-contact gesture recognition and providing a command to an electronically controlled host system comprising:
sampling a gestural target using a plurality of emitters and detectors energized according to a predetermined, time-varying sequence;
generating a time-varying sequence of electronic data from the samples;
performing projective feature extraction upon the time-varying sequence and submitting the extracted features to a computer-implemented pattern recognizer;
using the computer-implemented pattern recognizer to identify at least one gesture based on the submitted extracted features; and
outputting an electronic control command to the host system based on the at least one gesture so identified.

24. The method of claim 23 wherein the sampling step is performed by a processor according to a stored matrix that defines predetermined emitter-detector patterns.

25. The method of claim 24 further comprising constructing the stored matrix by preselecting patterns based on minimizing redundancy.

26. The method of claim 24 further comprising constructing the stored matrix by preselecting patterns based on maximizing relevance.

27. The method of claim 23 further comprising compressing the extracted features by applying a predetermined projection matrix.

28. The method of claim 23 wherein the computer-implemented pattern recognizer employs at least one Hidden Markov Model.

29. The method of claim 23 wherein the computer-implemented pattern recognizer employs a nearest neighbor algorithm.

30. The method of claim 23 wherein the computer-implemented pattern recognizer performs end point detection to ascertain when a gesture is completed.

31. The method of claim 30 wherein said electronic control command is outputted to the host system after end point detection has ascertained that a gesture is completed.
